(19) United States
(12) Patent Application Publication
(10) Pub. No.: US 2013/0262359 A1
(43) Pub. Date: Oct. 3, 2013

(54) INFORMATION PROCESSING APPARATUS, INFORMATION PROCESSING METHOD, AND STORAGE MEDIUM

(71) Applicant: CASIO COMPUTER CO., LTD., Tokyo (JP)

(72) Inventor: Masao SAMBONGI, Tokyo (JP)

(73) Assignee: CASIO COMPUTER CO., LTD., Tokyo (JP)

(21) Appl. No.: 13/845,318

(22) Filed: Mar. 18, 2013

(30) Foreign Application Priority Data
Mar. 28, 2012 (JP) 2012-074695

(51) Int. Cl. G06N 5/02

(52) U.S. Cl. CPC G06N 5/02
USPC 706/46

(57) ABSTRACT

A positional information acquisition unit 52 acquires positional information from a GPS unit 16. An internal user condition acquisition unit 53 acquires user condition information, which is output from the sensor unit 17, and which indicates predetermined internal user conditions. A history acquisition unit 55 associates the positional information acquired by the positional information acquisition unit 52 with the user condition information acquired by the internal user condition acquisition unit 53, and acquires these information as user behavior history. A behavior candidate presumption unit 56 presumes user behaviors after predetermined timing, and outputs the presumed behaviors as behavior candidates, based on the positional information acquired by the positional information acquisition unit 52 at the predetermined timing, the user condition information acquired by the internal user condition acquisition unit 53 at the predetermined timing, and the user behavior history acquired by the history acquisition unit 55 before the predetermined timing.

This application is based on and claims the benefit of priority from Japanese Patent Application No. 2012-074695, filed on 28 Mar. 2012, the content of which is incorporated herein by reference.

### BACKGROUND OF THE INVENTION

1. Field of the Invention

The present invention relates to an information processing apparatus, an information processing method, and a storage medium, in which user behaviors can be predicted with high accuracy.

2. Related Art

Conventionally, systems for predicting user behaviors (hereinafter referred to as “behavior prediction system”) have been researched and developed.

For example, Patent Document 1 (Japanese Unexamined Patent Application, Publication No. 2010-146276) discloses a technique relating to a behavior prediction system.

However, conventional behavior prediction systems predict user behaviors, based on only conditions being external to a user, such as a place and time in which the user exists.

Therefore, the accuracy of prediction by conventional behavior prediction systems is not sufficient.

### SUMMARY OF THE INVENTION

The present invention has been made in view of such a situation, and an object of the present invention is to predict user behaviors with high accuracy.

In order to achieve the above object, one aspect of the present invention is an information processing apparatus that includes:

a positional information acquisition unit that acquires positional information indicating a position of a terminal;

a user condition acquisition unit that acquires user condition information indicating predetermined internal conditions of a user;

a history acquisition unit that associates the positional information acquired by the positional information acquisition unit with the user condition information acquired by the user condition acquisition unit, and acquires these information as user behavior history; and

a behavior candidate presumption unit that presumes user behaviors after predetermined timing, and outputs the presumed behaviors as behavior candidates, based on the positional information acquired by the positional information acquisition unit at the predetermined timing, the user condition information acquired by the user condition acquisition unit at the predetermined timing, and the user behavior history acquired by the history acquisition unit before the predetermined timing.

In order to achieve the above object, one aspect of the present invention is an information processing method executed by an information processing apparatus, in which the method includes:

a positional information acquisition step of acquiring positional information indicating a position of a terminal;

a user condition acquisition step of acquiring user condition information indicating predetermined internal conditions of a user;

a history acquisition step of associating the positional information acquired in the positional information acquisition step with the user condition information acquired in the user condition acquisition step, and acquiring these information as user behavior history; and

a behavior candidate presumption step of presuming user behaviors after predetermined timing, and outputs the presumed behaviors as behavior candidates, based on the positional information acquired in the positional information acquisition step at the predetermined timing, the user condition information acquired in the user condition acquisition step at the predetermined timing, and the user behavior history acquired in the history acquisition step before the predetermined timing.

In order to achieve the above object, one aspect of the present invention is a storage medium storing a program for a computer that controls information processing, in which the program causes the computer to function as:

a positional information acquisition unit that acquires positional information indicating a position of a terminal;

a user condition acquisition unit that acquires user condition information indicating predetermined internal conditions of a user;

a history acquisition unit that associates the positional information acquired by the positional information acquisition unit with the user condition information acquired by the user condition acquisition unit, and acquires these information as user behavior history; and

a behavior candidate presumption unit that presumes user behaviors after predetermined timing, and outputs the presumed behaviors as behavior candidates, based on the positional information acquired by the positional information acquisition unit at the predetermined timing, the user condition information acquired by the user condition acquisition unit at the predetermined timing, and the user behavior history acquired by the history acquisition unit before the predetermined timing.

### BRIEF DESCRIPTION OF THE DRAWINGS

FIG. 1 is a block diagram showing a hardware configuration of an information processing apparatus according to an embodiment of the present invention;

FIG. 2 is a functional block diagram showing a functional configuration for executing user behavior processing, in the functional configuration of the information processing apparatus shown in FIG. 1;

FIG. 3 is a diagram showing an example of a table that stores past user behavior history stored in a history storage unit;

FIG. 4 is a diagram showing behavior patterns stored in a pattern storage unit;

FIG. 5 is a flowchart showing a flow of user behavior processing executed by the information processing apparatus shown in FIG. 1 having the functional configuration shown in FIG. 2;

FIG. 6 is a flowchart illustrating details of history acquisition processing in the user behavior processing shown in FIG. 5; and

FIG. 7 is a flowchart illustrating details of guidance processing in the user behavior processing shown in FIG. 5.

### DETAILED DESCRIPTION OF THE INVENTION

Descriptions are hereinafter provided for an embodiment of the present invention with reference to the drawings.

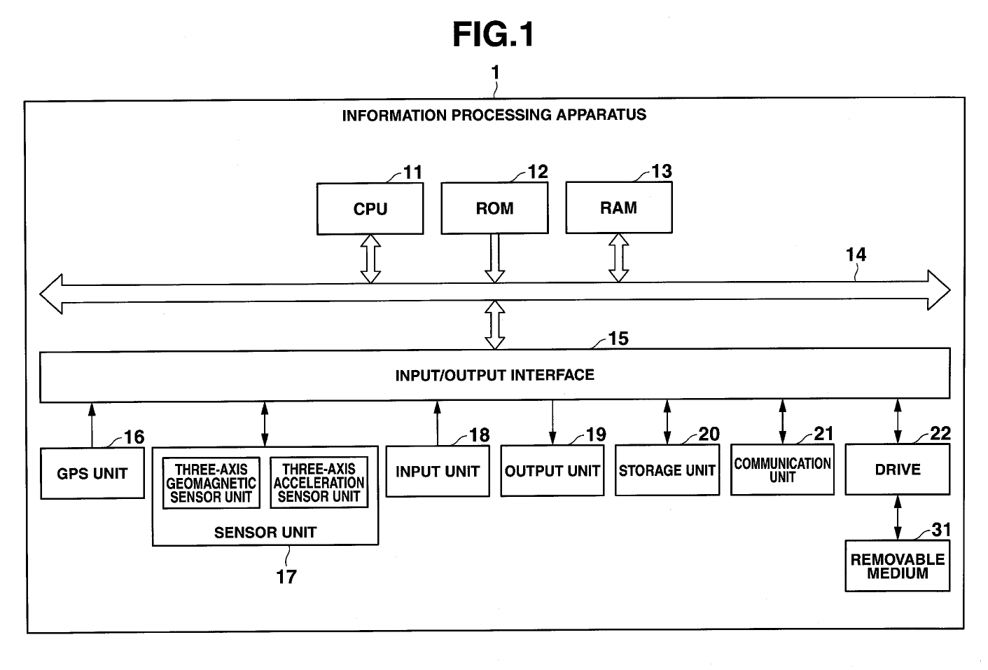

FIG. 1 is a block diagram showing a hardware configuration of an information processing apparatus according to the embodiment of the present invention.

An information processing apparatus 1 is configured as, for example, a smartphone.

The information processing apparatus 1 can pinpoint a position of the apparatus itself by receiving signals from several GPS (Global Positioning System) satellites in the sky.

The information processing apparatus 1 can acquire a travel distance, etc. of the apparatus itself involved with movement of a user.

The information processing apparatus 1 includes a CPU (Central Processing Unit) 11, ROM (Read Only Memory) 12, RAM (Random Access Memory) 13, a bus 14, an input/output interface 15, a GPS unit 16, a sensor unit 17, an input unit 18, an output unit 19, a storage unit 20, a communication unit 21, and a drive 22.

The CPU 11 executes a variety of processing according to programs that are recorded in the ROM 12, or programs that are loaded from the storage unit 20 to the RAM 13.

The RAM 13 also stores data and the like necessary for the CPU 11 to execute the variety of processing, as appropriate.

The CPU 11, the ROM 12 and the RAM 13 are connected to one another via the bus 14.

The bus 14 is also connected with the input/output interface 15.

The input/output interface 15 is connected to the input unit 18, the output unit 19, the storage unit 20, the communication unit 21, and the drive 22.

When the GPS unit 16 receives GPS signals from a plurality of GPS satellites, based on the GPS signals, the GPS unit 16 calculates data indicating a current position of the information processing apparatus 1, more specifically, each data of latitude, longitude and altitude (the data is hereinafter collectively referred to as “data of positional information”).

The sensor unit 17 measures change in a state involved with movement of the information processing apparatus 1.

In the present embodiment, the sensor unit 17 is configured to include a three-axis geomagnetic sensor and a three-axis acceleration sensor.

For example, by using an MI element whose impedance changes in response to fluctuation of an external magnetic field, the three-axis geomagnetic sensor detects three-axis (X, Y, Z) components of geomagnetism, and outputs three-axis geomagnetic data indicating a result of the detection.

The three-axis acceleration sensor detects three-axis acceleration components by a detection mechanism of piezo-resistance type or electrostatic capacity type, and outputs acceleration data for each of the three-axis components indicating a result of the detection.

The three-axis components detected by the three-axis acceleration sensor correspond to the three-axis (X, Y, Z) components of the three-axis geomagnetic sensor, respectively.

The input unit 18 is configured by various buttons and the like, and inputs a variety of information in accordance with instruction operations by a user.

The various buttons as used herein include not only hardware buttons but also software buttons displayed on a screen of the output unit 19.

In other words, the input unit 18 is configured to include a touch screen laminated on the display of the output unit 19.

The output unit 19 is configured by a display, a speaker and the like, and outputs images and sound.

The storage unit 20 is configured by DRAM (Dynamic Random Access Memory) or the like, and stores data of variety of information.

The communication unit 21 can control communication, which is performed through a network including the Internet, with other units such as a server (not shown) including another information processing apparatus 1.

A removable medium 31 composed of a magnetic disk, an optical disk, a magneto-optical disk, semiconductor memory or the like is installed in the drive 22, as appropriate.

Programs that are read via the drive 22 from the removable medium 31 are installed in the storage unit 20, as necessary.

Similarly to the storage unit 20, the removable medium 31 can also store a variety of data such as the data of information stored in the storage unit 20.

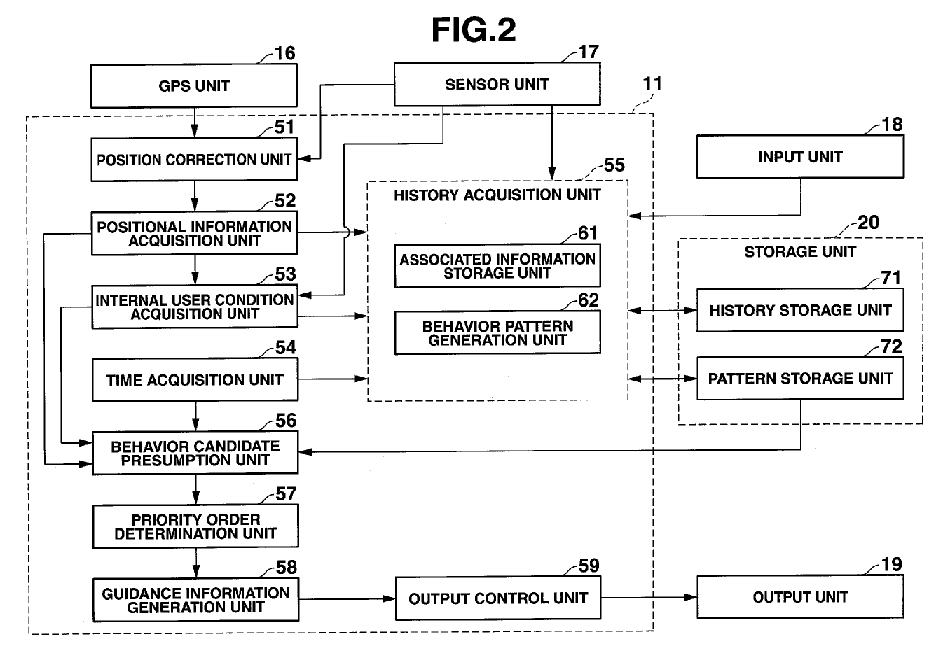

FIG. 2 is a functional block diagram showing a functional configuration for executing user behavior processing, in the functional configuration of the information processing apparatus 1 as described above.

The user behavior presumption processing refers to the following processing that is initiated when a user depresses a power button (not shown) of the input unit 18.

In other words, the user behavior processing refers to a sequence of processing, in which behavior history is acquired from context information of the user; behavior patterns are generated based on the acquired history; user behaviors are presumed based on the generated behavior patterns; and notification of guidance information is provided based on the presumed behaviors.

In the present specification, contexts refer to both internal and external user conditions. The internal user conditions refer to conditions attributable to actions of a body or a brain of the user, for example, behaviors, physical conditions, emotions (feelings and psychological conditions), etc. of the user.

The external conditions refer to spatially or temporally located position of the user (the temporally located position refers to, for example, the current time) as well as predetermined conditions distributed in spatial directions, temporal directions, or all directions around the user (conditions of an ambient environment).

In a case of controlling execution of the user behavior processing, a position correction unit 51, a positional information acquisition unit 52, a internal user condition acquisition unit 53, a time acquisition unit 54, a history acquisition unit 55, a behavior candidate presumption unit 56, a priority order determination unit 57, and a guidance information generation unit 58 function in the CPU 11.

A history storage unit 71 and a pattern storage unit 72 are provided as an area of the storage unit 20 of the information processing apparatus 1.

Providing the history storage unit 71 and the pattern storage unit 72 as an area of the storage unit 20 is an example.

As another example, such units may be provided as an area of the removable medium 31.

By using three-axis geomagnetic data and three-axis acceleration data that are output from the sensor unit 17, the position correction unit 51 generates supplementary information that is necessary for calculating data of alternative positional information (hereinafter referred to as “supplementary positional information”) of the GPS unit 16.

By using the supplementary positional information through so-called autonomous navigation, the position correction unit 51 corrects the data of the positional information that is output from the GPS unit 16.

For example, in a case in which the information processing apparatus 1 held by the user is located under an environment in which radio waves from the GPS satellites are available, the GPS unit 16 pinpoints the position of the information processing apparatus 1 based on the GPS signals, and outputs data of positional information.

In this case, the position correction unit 51 supplies the data of the positional information being output from the GPS unit 16 to the positional information acquisition unit 52 without any correction.

In contrast, in a case in which the information processing apparatus 1 is located under an environment such as a tunnel in which the pinpointing by the GPS unit 16 is difficult, the position correction unit 51 executes the following processing as its function.

More specifically, the case of being located under an environment where the positioning is difficult refers to a case in which the data of the positional information from the GPS unit 16 is cut off, or a case in which the GPS unit 16 is intermittently driven and operated to output data of positional information.

In other words, based on the three-axis geomagnetic data that is output from the sensor unit 17, the position correction unit 51 generates a direction of movement of the information processing apparatus 1, as supplementary positional information.

By integrating the three-axis acceleration data that is sequentially output from the sensor unit 17, the position correction unit 51 calculates a travel distance of the information processing apparatus 1, as supplementary positional information.

Here, the travel distance refers to a distance from a position of a predetermined start point to a current position of the information processing apparatus 1.

In other words, the position of the predetermined start point refers to a position of the information processing apparatus 1 at a point in time when the position correction unit 51 starts integration, i.e. at a point in time when the integration is set to zero by the initial setup, or at a point in time when the integration is reset to zero thereafter.

Based on the supplementary positional information that is generated in this manner, the position correction unit 51 corrects the data of positional information that is output from the GPS unit 16.

The position correction unit 51 generates correction information as necessary, and corrects the supplementary positional information, based on the correction information.

Generation of the correction information requires the history of the supplementary positional information that was generated when the data of positional information was output from the GPS unit 16 in the past.

Accordingly, regardless of whether data of positional information is output from the GPS unit 16, the position correction unit 51 generates supplementary positional information at any time.

The position correction unit 51 stores calculation results of the position correction unit 51 and information necessary for the calculation into an area of the storage unit 20, as appropriate.

For example, the position correction unit 51 stores the position correction information that is output, i.e. a travel direction and a travel distance of the information processing apparatus 1, into the storage unit 20.

The position correction unit 51 generates information for correcting errors of the position correction information (a travel direction and a travel distance of the information processing apparatus 1) (hereinafter referred to as “error correction information”), the errors being attributable to results of detection by the sensor unit 17.

In this case, the sensor unit 17 corrects the position correction information by using the error correction information.

As a result, it is possible to obtain position correction information, in which the errors being attributable to results of detection by the sensor unit 17 are reduced.

In other words, results of detection by the sensor unit 17 are susceptible to an effect of temperature.

Therefore, errors of position correction information occur as a result of detection by the sensor unit 17 that receives an effect of temperature.

Accordingly, at any time, the position correction unit 51 calculates difference between the travel direction and the travel distance that are calculated and the travel direction and the travel distance that are identified by the positional information that is output from the GPS unit 16.

The position correction unit 51 associates data indicating calculation results (hereinafter referred to as “difference data”) with a temperature and temperature variations when the difference data was obtained, and the data is stored as error correction information into the position correction unit 51.

In this case, when the position correction unit 51 calculates a travel direction and a travel distance, the position correction unit 51 acquires difference data corresponding to the temperature at the point in time of calculation as supplementary information from the position correction unit 51.

The position correction unit 51 corrects the position correction information by using the error correction information.

As a result, it is possible to obtain position correction information, in which the errors being attributable to results of detection by the sensor unit 17 are reduced.

The positional information acquisition unit 52 repeats an attempt to acquire data of positional information indicating the current position from the GPS unit 16 (hereinafter referred to as “GPS positional information” so as to be distinguished from the other positional information) at a predetermined time interval.

In a case in which the positional information acquisition unit 52 succeeds in acquisition of the data of the GPS positional information, the positional information acquisition unit 52 supplies the data of the GPS positional information to the internal user condition acquisition unit 53, the history acquisition unit 55, and the behavior candidate presumption unit 56.

Based on a result of detection by the sensor unit 17, the internal user condition acquisition unit 53 acquires information indicating the internal user conditions (particularly a movement condition of the user) (hereinafter referred to as “user condition information”).

For example, when the internal user condition acquisition unit 53 acquires three-axis acceleration data that is output from the sensor unit 17, the internal user condition acquisition unit 53 obtains an oscillation period based on the three-axis acceleration data, and acquires user condition information by mainly using the vertical oscillation period (the oscillation period obtained from the X component).

A sequence of processing that is executed in this manner by the internal user condition acquisition unit 53 to acquire user condition information is hereinafter referred to as “condition acquisition processing”.

Here, types of the user condition information that can be detected by the condition detection processing are not particularly limited so long as the information indicates arbitrary types of internal user conditions; however, at least a plurality of types thereof are necessary.

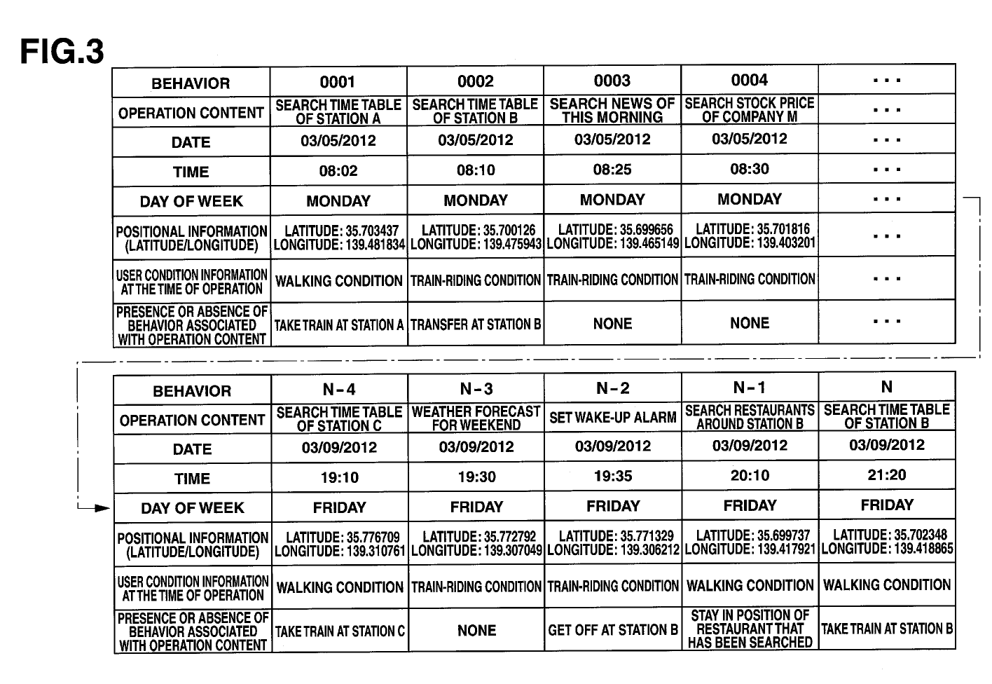

Accordingly, in the present embodiment, as shown in FIG. 3, user condition information indicating four types of movement conditions, i.e. a halt condition, a walking condition, a running condition, or a train-riding condition can be detected by the condition detection processing.

For example, in a case in which each component of the three-axis acceleration data that is output from the sensor unit 17 is substantially zero, the case satisfies a condition that the three-axis acceleration sensor detects no acceleration.

As a result, the user condition information is acquired, which indicates that the movement condition of the user is the “halt condition”.

Similarly, in a case in which the vertical oscillation period obtained from the X component of the three-axis acceleration data that is output from the sensor unit 17 is approximately 2 Hz, the case satisfies a condition that the three-axis acceleration sensor detects a vertical oscillation period of 2 Hz.

As a result, the user condition information is acquired, which indicates that the movement condition of the user is the “walking condition”.

Similarly, in a case in which the vertical oscillation period obtained from the X component of the three-axis acceleration data that is output from the sensor unit 17 is 2 Hz or greater, the case satisfies a condition that the three-axis acceleration sensor detects a vertical oscillation period of 2 Hz or greater.

As a result, the user condition information is acquired, which indicates that the movement condition of the user is the “running condition”.

Similarly, in a case in which the vertical oscillation period obtained from the X component of the three-axis acceleration data that is output from the sensor unit 17 is a particular value or less, the horizontal oscillation period obtained from the Y component of the three-axis acceleration data is a predetermined value or greater, and no acceleration acting in a direction reverse to the Y component is detected after detecting the Y component of the three-axis acceleration data that is output from the three-axis acceleration sensor of the sensor unit 17, the case satisfies a condition that the three-axis acceleration sensor detects a vertical oscillation period of a small value, and a horizontal oscillation period of a predetermined value or greater, and no reverse acceleration (halt action) thereafter.

As a result, the user condition information is acquired, which indicates that the movement condition of the user is the “train-riding condition”.

When the internal user condition acquisition unit 53 executes the condition detection processing in this manner, the internal user condition acquisition unit 53 supplies the processing result, i.e. the user condition information indicating the detected user condition, to the behavior candidate presumption unit 56 and the history acquisition unit 55.

The time acquisition unit 54 acquires the time when the positional information acquisition unit 52 acquires positional information.

The time source is not limited in particular, and may be a clock (timing unit) (not shown) built into the information processing apparatus 1, and may be time information included in externally supplied information (for example, GPS signals).

The time acquisition unit 54 supplies the information indicating the acquired time to the history acquisition unit 55 and the behavior candidate presumption unit 56.

The history acquisition unit 55 acquires, as one of the past user behavior history, the positional information acquired by the positional information acquisition unit 52, and the user condition information acquired by the internal user condition acquisition unit 53, and then stores the information into the history storage unit 71.

In a case in which the history acquisition unit 55 controls execution of such processing, an associated information storage unit 61 and a behavior pattern generation unit 62 function in the history acquisition unit 55.

In a case in which there is an operation when the user condition information acquired by the internal user condition acquisition unit 53 is changed, the associated information storage unit 61 acquires an operation content associated with a content of an operation by the user as associated information, and stores the operation content into the history storage unit 71.

Based on the past user behaviors stored in the associated information storage unit 61, the behavior pattern generation unit 62 generates a plurality of user behavior patterns.

The behavior pattern generation unit 62 stores the generated behavior patterns into the pattern storage unit 72.

User behaviors are presumed based on the past user behavior history acquired by the history acquisition unit 55.

Here, with reference to FIG. 3, descriptions are provided for the processing by the history acquisition unit 55 that stores the past user behavior history into the history storage unit 71.

FIG. 3 is a diagram showing an example of a table that stores the past user behavior history stored in the history storage unit 71. For each of the user behaviors performed for N times (N is a natural number), the table in the history storage unit 71 stores an operation content, a date, time, a day of week, positional information, user condition information at the time of operation, and presence or absence of behavior associated with the operation content.

At first, as the past user behavior history 0001, the history acquisition unit 55 acquires behavior contents such as an operation content, a date, time, a day of week, positional information, and user condition information at the time of operation.

More specifically, when the user performs a terminal operation, the history acquisition unit 55 acquires operation contents of the information processing apparatus 1 via the input unit 18 as the user behavior contents.

When the user performs the terminal operation, the history acquisition unit 55 acquires information of a date, time, and a day of week, as the user behavior contents, from the time acquisition unit 54.

When the user performs the terminal operation, the history acquisition unit 55 acquires positional information as the user behavior content from the positional information acquisition unit 52.

When the user performs the terminal operation, the history acquisition unit 55 acquires the user condition information as the user behavior content from the internal user condition acquisition unit 53.

In the present embodiment, in terms of the user behavior history 0001, “search time table of Station A” is acquired as an operation content, “2012/03/05” is acquired as a date, “08:02” is acquired as time, and “Monday” is acquired as a day of week.

Furthermore, in terms of the user behavior history 0001, “latitude: 35.703437, longitude: 139.481834” is acquired as positional information, and “walking condition” is acquired as user condition information.

Similarly, in terms of user behavior history 0002, “search time table of transfer Station B” is acquired as an operation content, “2012/03/05” is acquired as a date, “08:10” is acquired as time, “Monday” is acquired as a day of week, and “latitude: 35.700126, longitude: 139.475943” is acquired as positional information.

Furthermore, in terms of the user behavior history 0002, “train-riding condition” is acquired as user condition information.

The history acquisition unit 55 stores the acquired user behavior contents into the history storage unit 71.

In a case in which the operation content is determined to be associated with the user condition information, the operation content associated with the operation content is stored as the associated information into the information storage unit 6.

In the present embodiment, in terms of the user behavior history 0001, “take a train at Station A” is stored as the associated information that is associated with the operation content “search time table of Station A”.

In terms of the user behavior history 0002, “transfer at Station B” is stored as the associated information that is associated with the operation content “search time table of transfer Station B”.

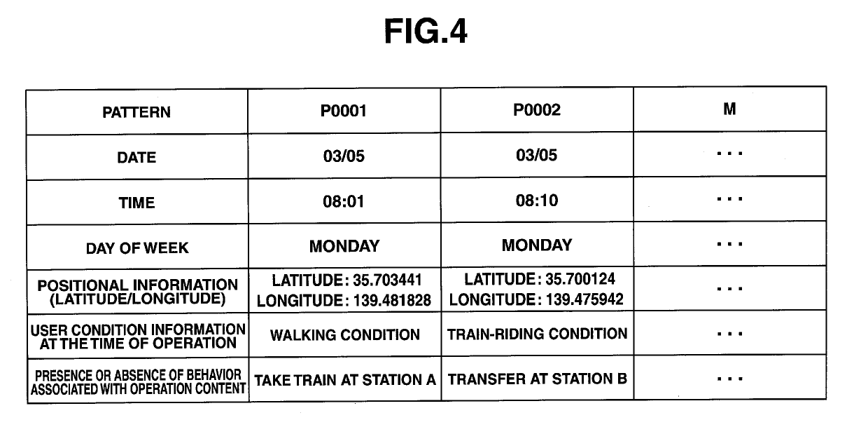

With reference to FIG. 4, descriptions are provided for the processing by the behavior candidate presumption unit 56 that presumes behavior candidates indicating future user behaviors based on the past user behaviors.

FIG. 4 is a diagram showing behavior patterns stored in the pattern storage unit 72.

For each of M behavior patterns (M is a natural number), the pattern storage unit 72 stores situations including a date, time, a day of week, positional information, user condition information at the time of operation, and presence or absence of behavior associated with the operation content.

For each of the behaviors N stored in the history storage unit 71, the behavior pattern generation unit 62 determines each behavior pattern through standardization based on an average and the like of a date, time, a day of week, positional information, user condition information at the time of operation, and presence or absence of behavior associated with the operation content.

Here, descriptions are provided for an example in which the behavior candidate presumption unit 56 presumes behavior candidates.

The behavior candidate presumption unit 56 acquires “latitude: 35.703440, longitude: 139.481827” as the positional information acquired by the positional information acquisition unit 52.

The behavior candidate presumption unit 56 acquires “walking condition” as the user condition information acquired by the internal user condition acquisition unit 53.

The behavior candidate presumption unit 56 acquires “8:02” as the time and “Monday” as the day of week acquired by time acquisition unit 54.

In this case, the behavior candidate presumption unit 56 presumes a pattern P0001 as a behavior candidate that coincides with, or is similar to, the user behavior.

A plurality of behavior candidates can be presumed if possible.

The guidance information generation unit 58 generates guidance information for guiding the user with information corresponding to an operation content of a pattern P0002 that is considered be performed subsequently to the pattern P0001, as information resulting from the behavior candidate presumed the by behavior candidate presumption unit 56.

In the present embodiment, since the operation content in P0002 is “search time table of transfer Station B”, the guidance information generation unit 58 generates guidance information for displaying a time table of Station B on the display of the output unit 19.

Based on the generated guidance information, the output control unit 59 controls the display of the output unit 19 to display the time table of Station B.

As another example, descriptions are provided for a case in which a user A gets on a train line o at Station O to travel and get off at Station T.

The internal user condition acquisition unit 53 can grasp that the movement condition of the user A is changed from “train-riding condition” to “halt condition” at Station T.

At this time, based on the behavior patterns stored in the pattern storage unit 72, the behavior candidate presumption unit 56 analyzes the daily behavior patterns of the user A, and analyzes a behavior content based on the time.

In a case in which the analysis results in determination that the user A frequently transfers to a train line c at Station T, guidance information for displaying a time table of Station T for the train line c is generated, and the time table of Station T is displayed.

As another example, descriptions are provided for a case in which a user B gets on the train line o at Station O to travel and get off at Station T.

The internal user condition acquisition unit 53 can grasp that the movement condition of the user B is changed from “train-riding condition” to “halt condition” at Station T.

At this time, based on the behavior patterns stored in the pattern storage unit 72, the behavior candidate presumption unit 56 analyzes the daily behavior patterns of the user B, and analyzes a behavior content based on the time.

In a case in which the analysis results in determination that the user frequently gets off at Station T and walks to a destination F, guidance information for displaying a map and presumed time from Station T to the destination F is generated, and the map and the presumed time from Station T to the destination F is displayed.

In this way, habitual user behaviors are analyzed to grasp trends, behavior patterns are generated based on the grasped trends, and future behaviors are presumed based on the generated behavior patterns.

As a result, different guidance is output for the user A and the user B who have both taken a similar behavior under the same conditions.

In other words, by recording individual user behaviors in addition to current information, future behaviors are presumed based on information obtained by analyzing trends.

As a result, instead of predicting behaviors by fixed data and providing a similar result for whoever performs a behavior, the operation result (search result) includes personal difference that is optimized for each individual by adding private information of users.

As another example, descriptions are provided for a case in which a user C commutes on a train at the same time every day.

In a case in which the behavior candidate presumption unit 56 grasps that the movement condition of the user C is “train-riding condition” at Station T around the acquired time, the behavior candidate presumption unit 56 analyzes the daily behavior patterns of the user C, and analyzes the behavior content at the time, based on the behavior patterns stored in the pattern storage unit 72.

In a case in which the analysis results in determination that the user C frequently sets a wake-up alarm after getting on a train at Station T, guidance information for outputting a wake-up alarm tone from a speaker of the output unit 19 after a predetermined period of time is generated, and the wake-up alarm tone is output from the speaker.

In other words, by grasping the daily user habits based on the past user behaviors, a place and time for transferring and/or getting off trains can be predicted in advance; therefore, the user can be notified of such information without setting a wake-up alarm.

As a result, the user is free from worries about setting an alarm.

As another example, descriptions are provided for a case in which a user D takes a train at Station M to travel to Station S.

In a case in which the time required for arriving at the destination by transferring to a train line s at Station A to travel to Station Y is shorter than the time ordinarily required for arriving at the destination by getting on a train line k at Station M to travel to Station S, the guidance information generation unit 58 generates guidance information for outputting an alarm before Station A.

As a result, the user can be notified of the fact that arrival at the destination will become earlier by transferring at Station A.

As a result, for example, even in a case in which the user gets on a frequently-taken train line, a route of the shortest time can be output from the output unit 19 without the need of searching for train lines.

Therefore, since a search engine can be operated by predicting behaviors based on the user habits, the user can benefit from guidance information that was unknown to the user himself/herself.

As another example, descriptions are provided for a case in which the user takes a search action before a station (for example, Station C) that is ordinarily passed by the user remaining on a train.

In this case, in a case in which a search is performed as an operation content by using a search keyword “place to eat” near Station C, the behavior candidate presumption unit 56 presumes behavior candidates, in which a search for places to eat near the transfer station (Station C) will be performed, and a search for places to eat around each stopover station will be subsequently performed, and the behavior candidate presumption unit 56 preferentially generates the search results as guidance information.

In a case in which the user condition information is currently the train-riding condition, in terms of stations for searching, places to eat in front of the stations are preferentially output, or places to eat around the stations where the user may transfer are preferentially output.

The results are not simple outputs of places near the currently located station, and are therefore different from automatically displayed search results.

With reference to FIG. 2 again, the behavior candidate presumption unit 56 presumes user behaviors after predetermined timing, and outputs the presumed behaviors as behavior candidates, based on the positional information acquired by the positional information acquisition unit 52 at the predetermined timing, the user condition information acquired by the internal user condition acquisition unit 53 at the predetermined timing, the time acquired by the time acquisition unit 54, and the user behavior history acquired by the history acquisition unit 55 before the predetermined timing.

More specifically, based on behavior patterns generated by the behavior pattern generation unit 62, the behavior candidate presumption unit 56 presumes a plurality of user behaviors, and outputs the plurality of behaviors as a plurality of behavior candidates, respectively.

By referring to the associated information stored in the associated information storage unit 61, the behavior candidate presumption unit 56 presumes behaviors, and outputs the presumed behaviors as behavior candidates.

The behavior candidate presumption unit 56 supplies the output behavior candidates to the priority order determination unit 57.

The priority order determination unit 57 determines a priority order of the plurality of behavior candidates that are output from the behavior candidate presumption unit 56.

For example, among the plurality of behavior candidates that are output from the behavior candidate presumption unit 56, the priority order determination unit 57 determines whether any information, which corresponds to the acquired positional information, the user condition information, or the time, is a behavior candidate being close to the information of the generated behavior pattern.

As the behavior candidate is closer to the information of the behavior pattern, a priority order thereof is determined to be higher.

The priority order determination unit 57 supplies the information of the determined priority order to the guidance information generation unit 58.

The guidance information generation unit 58 generates guidance information for guiding the user with information resulting from the plurality of behavior candidates that are output from the behavior candidate presumption unit 56.

More specifically, among the plurality of behavior candidates that are sorted based on the priority order determined by the priority order determination unit 57, the guidance information generation unit 58 generates guidance information for guiding the user with information resulting from a behavior candidate having the highest priority order.

For example, in a case in which a behavior candidate of searching a time table of Station A at 8:02 on Monday is presumed as information resulting from the behavior candidate, the guidance information generation unit 58 subsequently generates information for displaying a time table of the transfer Station B on the display of the output unit 19.

The guidance information generation unit 58 supplies the generated guidance information to the output control unit 59.

The output control unit 59 controls the display and/or the speaker of the output unit 19 to output the generated guidance information.

For example, in a case in which information of a time table is generated as guidance information, the output control unit 59 controls the output unit 19 to display the time table.

In a case in which information of an alarm regarding a train is generated as guidance information, the output control unit 59 controls the speaker of the output unit 19 to output an alarm tone.

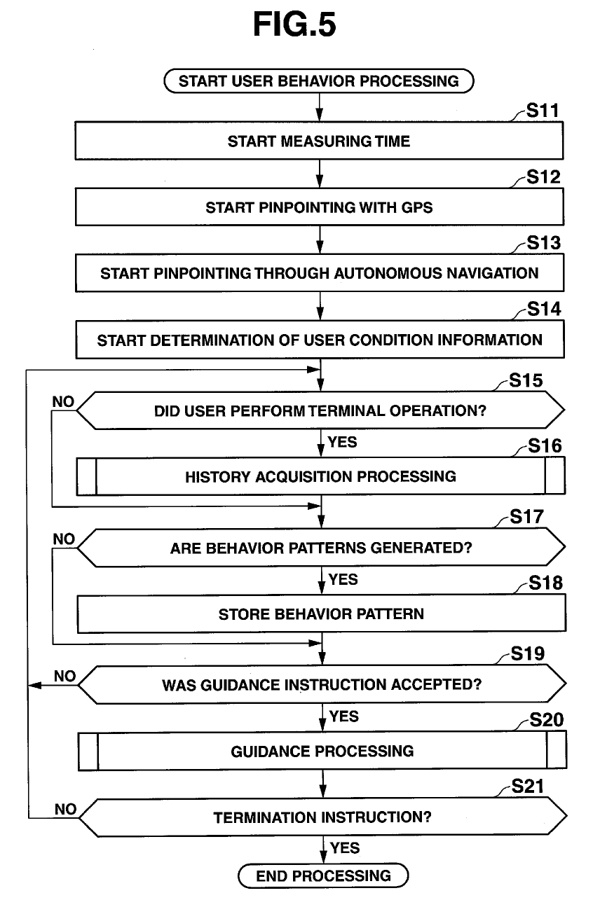

Next, with reference to FIG. 5, descriptions are provided for the user behavior processing executed by the information processing apparatus 1 having the functional configuration as shown in FIG. 2.

FIG. 5 is a flowchart showing a flow of the user behavior processing executed by the information processing apparatus 1 shown in FIG. 1 having the functional configuration shown in FIG. 2.

The user behavior processing is initiated when the user depresses the power button of the input unit 18 of the information processing apparatus 1 (see FIG. 1), in which the following processing is repeatedly executed.

In Step S11, the time acquisition unit 54 controls a clock (not shown) to start measuring time, and acquires the time.

In Step S12, the positional information acquisition unit 52 controls the GPS unit 16 to start measuring GPS coordinates, and acquires data of positional information.

In Step S13, the position correction unit 51 controls the sensor unit 17 to start pinpointing through autonomous navigation, and corrects the data of the positional information from the GPS unit 16.

In Step S14, the internal user condition acquisition unit 53 starts determining user condition information, and acquires data of the user condition information.

In Step S15, the history acquisition unit 55 determines whether a terminal operation is executed by the user operating the input unit 18.

In a case in which a terminal operation is not executed, the determination in Step S15 is NO, and the processing advances to Step S17.

Processing in and after Step S17 will be described later. In a case in which a terminal operation is executed, the determination in Step S15 is YES, and the processing advances to Step S16.

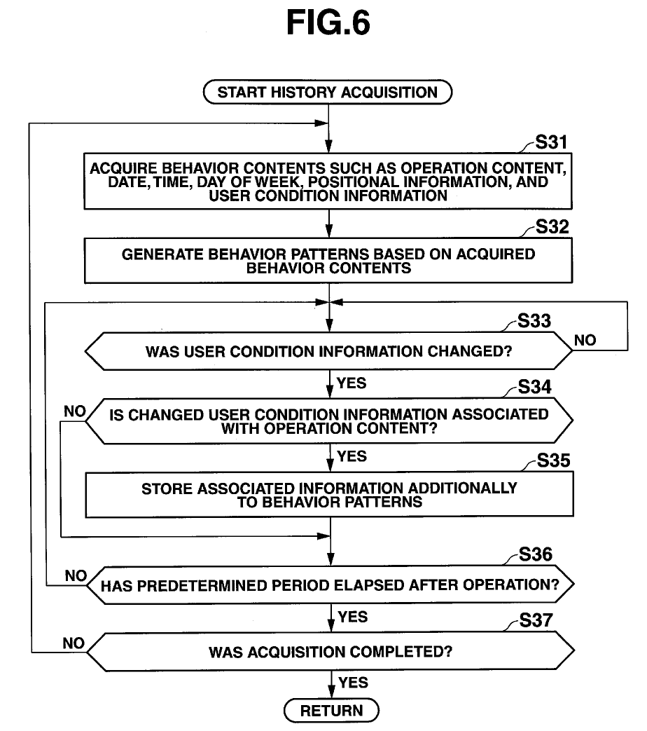

In Step S16, the history acquisition unit 55 executes history acquisition processing (to be described later with reference to FIG. 6).

In this processing, the history acquisition unit 55 generates behavior patterns, based on the acquired behavior contents.

When this processing is completed, the processing advances to Step S17.

In Step S17, the behavior pattern generation unit 62 determines whether behavior patterns are generated in the history acquisition processing in Step S16.

In a case in which behavior patterns are not generated, the determination in Step S17 is NO, and the processing advances to Step S19.

Processing in and after Step S19 will be described later.

In a case in which behavior patterns are generated, the determination in Step S17 is YES, and the processing advances to Step S18.

In Step 18, the behavior pattern generation unit 62 stores the generated behavior patterns into the pattern storage unit 72 of the storage unit 20.

In Step S19, the guidance information generation unit 58 determines whether the user accepted a guidance instruction by operating the input unit 18.

In a case in which the guidance instruction is not accepted, the determination in Step S19 is NO, and the processing returns to Step S15.

In other words, the processing in Steps S15 to S19 is repeated until the guidance instruction is accepted.

In a case in which the guidance instruction is accepted, the determination in Step S19 is YES, and the processing advances to Step S20.

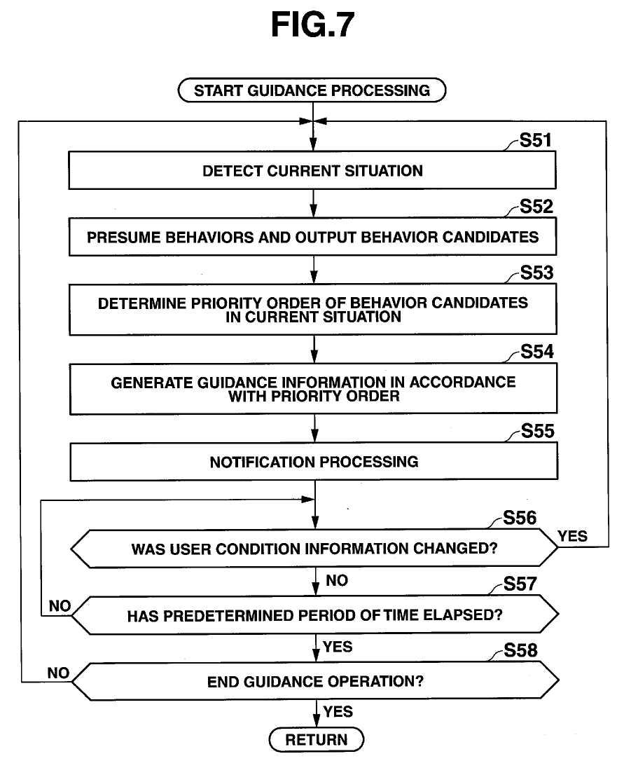

In Step S20, the CPU 11 executes guidance processing (to be described later with reference to FIG. 7).

In this processing, the CPU 11 presumes a plurality of behavior candidates based on the current situations and the behavior patterns, determines a priority order of the plurality of presumed behavior candidates, generates guidance information by following the determined priority order, and provides notification of the guidance information.

In Step S21, the CPU 11 determines whether an instruction of terminating the user behavior processing is received.

In a case in which a terminating instruction is not received, the determination in Step S21 is NO, and the processing returns to Step S15 again.

On the other hand, in a case in which a terminating instruction is received, the determination in Step S21 is YES, and the user behavior processing is terminated.

Next, detailed descriptions are provided for the history acquisition processing in Step S16 in the user behavior processing.

FIG. 6 is a flowchart illustrating details of the history acquisition processing in Step S16 in the user behavior processing shown in FIG. 5.

As described above, the history acquisition processing is initiated as the processing in Step S16 when the user performs a terminal operation.

In Step S31, the history acquisition unit 55 acquires behavior contents such as an operation content, a date, time, a day of week, positional information, and user condition information at the time of operation.

In Step S32, the history acquisition unit 55 generates behavior patterns, based on the behavior contents acquired in Step S31.

The history acquisition unit 55 stores the acquired behavior patterns into the pattern storage unit 72.

In Step S33, the internal user condition acquisition unit 53 determines whether the user condition information is changed.

In a case in which the user condition information is not changed, the determination in Step S33 is NO, and the processing returns to Step S33.

In other words, the history acquisition processing is in a stand-by state until the user condition information is changed.

In a case in which the user condition information is changed, the determination in Step S33 is YES, and the processing advances to Step S34.

In Step S34, the history acquisition unit 55 determines whether the operation contents operated by the user via the input unit 18 are associated with the user condition information that is changed.

In a case in which the operation contents are not associated with the changed user condition information, the determination in Step S34 is NO, and the processing advances to Step S36.

Processing in and after Step S36 will be described later.

In a case in which the operation contents are associated with the changed user condition information, the determination in Step S34 is YES, and the processing advances to Step S35.

In Step S35, the associated information storage unit 61 stores the associated information in addition to the behavior patterns generated in Step S32.

More specifically, in a case in which the behavior contents acquired in Step S31 are closely associated with the operation contents operated by the user via the input unit 18, the associated information storage unit 61 identifies the operation contents corresponding to the behavior contents, and adds information indicating the identified associated operation contents as the associated information to the record of the generated behavior patterns.

In Step S36, the history acquisition unit 55 determines whether a predetermined period of time has elapsed since the user performed an operation.

In a case in which the predetermined period of time has not elapsed since the user performed an operation, the determination in Step S36 is NO, and the processing returns to Step S33.

In other words, the processing in Steps S33 to S36 is repeated until a predetermined period of time has elapsed since the user performed an operation.

In a case in which the predetermined period of time has elapsed since the user performed an operation, the determination in Step S36 is YES, and the processing advances to Step S37.

In Step S37, the history acquisition unit 55 determines whether the acquisition of behavior contents is completed.

In a case in which the acquisition of behavior contents is not completed, the determination in Step S37 is NO, and the processing returns to Step S31.

In other words, the processing in Steps S31 to S37 is repeated until the acquisition of behavior contents is completed.

In a case in which the acquisition of behavior contents is completed, the determination in Step S37 is YES, and the history acquisition processing is terminated.

Next, detailed descriptions are provided for the guidance processing in Step S20 in the user behavior processing shown in FIG. 5.

FIG. 7 is a flowchart illustrating details of the guidance processing in Step S20 in the user behavior processing shown in FIG. 5.

As described above, the guidance processing is initiated as the processing in Step S20 when a guidance instruction is accepted by the user operating the input unit 18.

In Step S51, the behavior candidate presumption unit 56 detects the current situations of the information processing apparatus 1.

The current situations refer to situations including the current position of the information processing apparatus 1, the user condition information, and the time.

Therefore, in this processing, the behavior candidate presumption unit 56 detects current situations, based on the positional information acquired by the positional information acquisition unit 52, the user condition information acquired by the internal user condition acquisition unit 53, and the time acquired by the time acquisition unit 54.

In Step S52, the behavior candidate presumption unit 56 presumes behaviors based on the current situations detected in Step S51, and outputs behavior candidates.

In Step S53, the priority order determination unit 57 determines a priority order of the behavior candidates in the current situations detected in Step S51.

In Step S54, the guidance information generation unit 58 generates guidance information by following the priority order determined in Step S53.

In Step S55, the output control unit 59 executes guidance processing, based on the guidance information generated in Step S54.

The guidance processing refers to processing of outputting guidance information from the display, the speaker or the like of the output unit 19, based on generated guidance information.

In Step S56, the internal user condition acquisition unit 53 determines whether the user condition information is changed.

In a case in which the user condition information is changed, the determination in Step S56 is YES, and the processing returns to Step S51.

In other words, the processing in Steps S51 to S56 is repeated each time the user condition information is changed. In a case in which the user condition information is not changed, the determination in Step S56 is NO, and the processing advances to Step S57.

In Step S57, the time acquisition unit 54 determines whether a predetermined period of time has elapsed.

In a case in which the predetermined period of time has not elapsed, the determination in Step S57 is NO, the processing returns to Step S56, and the processing in Steps S56 and S57 is repeated.

In other words, the guidance processing is in a stand-by state until the predetermined period of time has elapsed.

In a case in which the predetermined period of time has elapsed, the determination in Step S57 is YES, and the processing advances to Step S58.

In Step S58, the guidance information generation unit 58 determines whether an instruction of terminating the guidance operation is made.

In a case in which an instruction of terminating the guidance operation is not made, the determination in Step S58 is NO, and the processing returns to Step S51.

In a case in which an instruction of terminating the guidance operation is made, the determination in Step S58 is YES, and the guidance processing is terminated.

As described above, the information processing apparatus 1 of the present embodiment includes the positional information acquisition unit 52, the internal user condition acquisition unit 53, the history acquisition unit 55, and the behavior candidate presumption unit 56.

The positional information acquisition unit 52 acquires positional information from the GPS unit 16 indicating a position of the terminal held by the user.

The internal user condition acquisition unit 53 acquires user condition information from the sensor unit 17 indicating predetermined internal user conditions.

The history acquisition unit 55 associates the positional information acquired by the positional information acquisition unit 52 with the user condition information acquired by the internal user condition acquisition unit 53, and acquires these information as the user behavior history.

The behavior candidate presumption unit 56 presumes user behaviors after predetermined timing, and outputs the presumed behaviors as behavior candidates, based on the positional information acquired by the positional information acquisition unit 52 at the predetermined timing, and the user condition information acquired by the internal user condition acquisition unit 53 at the predetermined timing.

As a result, the user behaviors can be presumed as the behavior candidates by considering not only external user conditions such as a place, but also internal user conditions (for example, halt condition, walking condition, train-riding condition, etc.).

By accumulating ordinary user behaviors and analyzing such information to grasp trends, different future behaviors to be performed by different users who have taken a similar behavior under the same conditions can be presumed and output as behavior candidates.

In other words, since behaviors are predicted by recording each individual user behavior, and by adding information of trend analyses to the current information, each user behavior can be presumed by utilizing private information of each user.

As a result, since future user behaviors can be output as behavior candidates based on the past user behaviors associated with the positional information and the user condition information, the future user behaviors can be predicted with high accuracy.

The information processing apparatus 1 further includes the time acquisition unit 54.

The time acquisition unit 54 acquires the time when the positional information acquisition unit 52 acquires positional information.

The history acquisition unit 55 further associates the time acquired by the time acquisition unit 54 with the positional information and the user condition information, and acquires these information as the user behavior history.

Based on the positional information and the user condition information acquired at predetermined timing, the user behavior history before the predetermined timing, and the time acquired by the time acquisition unit 54 at the predetermined timing, the behavior candidate presumption unit 56 presumes user behaviors after the predetermined timing, and outputs the presumed behaviors as behavior candidates.

As a result, behaviors can be presumed based on the positional information and the user information corresponding to the time, and the presumed behavior candidates can be output.

Since behavior candidates can be output based on the past user behaviors associated with the time, the user behaviors can be predicted with higher accuracy.

The history acquisition unit 55 of the information processing apparatus 1 further includes the associated information storage unit 61.

When the user condition information acquired by the internal user condition acquisition unit 53 is changed, the associated information storage unit 61 identifies an operation associated with operation contents of the information processing apparatus 1 operated by the user, and stores information indicating the identified associated operation contents as associated information.

By referring to the associated information stored in the associated information storage unit 61, the behavior candidate presumption unit 56 presumes user behaviors, and outputs the presumed behaviors as behavior candidates.

As a result, instead of presuming behaviors by fixed data such as keywords, time, and places, behaviors can be presumed by using private information corresponding to the user, by storing the operation contents associated with the user condition information as the associated information in advance.

Therefore, in a case in which the user condition coincides with the user condition information of the past, operation contents regarding the associated information corresponding to the individual user condition information can be presumed as user behaviors, and the presumed behavior candidates can be output.

Therefore, future user behaviors can be predicted with high accuracy.

The history acquisition unit 55 of the information processing apparatus 1 further includes the behavior pattern generation unit 62.

The behavior pattern generation unit 62 generates a plurality of user behavior patterns, based on the past user behavior history that is stored.

Based on the behavior patterns generated by the behavior pattern generation unit 62, the behavior candidate presumption unit 56 presumes user behaviors, and outputs the presumed behaviors as behavior candidates.

As a result, future user behaviors can be presumed based on information of a behavior pattern that coincides with, or is similar to, the current user behavior.

Therefore, the accuracy of presuming the user behaviors can be increased by accumulating a plurality of behavior patterns in advance.

The information processing apparatus 1 further includes the guidance information generation unit 58.

The guidance information generation unit 58 generates guidance information for guiding the user with information resulting from the behavior candidates that are output from the behavior candidate presumption unit 56.

As a result, for example, in a case in which a presumed behavior candidate is “search time table of Station A”, the guidance information generation unit 58 generates guidance information for displaying the time table of Station A on the display of the output unit 19, in which the time table is information resulting from the presumed behavior candidate.

Similarly, in a case in which a presumed behavior candidate is the setting of a wake-up alarm, the guidance information generation unit 58 generates guidance information for outputting an alarm tone from the speaker of the output unit 19 after a predetermined period of time, in which the alarm tone is information resulting from the presumed behavior candidate.

As a result, even in a case in which different users have taken a similar behavior under the same condition, guidance information corresponding to each user is generated.

As a result, guidance information reflecting private information of the user can be generated, instead of providing guidance based on fixed data.

As a result, although it has been conventionally impossible to output operation contents such as search results unless the user performs an operation (action), the search results can be output in advance by using positional information as a trigger, or can be reported to the user by using a notification function such as an alarm.

Therefore, even in a case in which the user does not take any action, it is possible to output information that is predicted to be required by the user.

Instead of fixed information such information that is mechanically reported to the user by the notification function such as an alarm, the user can obtain helpful information without particular thought.

The behavior candidate presumption unit 56 of the information processing apparatus 1 presumes a plurality of user behaviors, and outputs the plurality of behaviors as a plurality of behavior candidates, respectively.

The information processing apparatus 1 further includes the priority order determination unit 57 that determines a priority order of the plurality of behavior candidates that are output from the behavior candidate presumption unit 56.

In the order that is determined based on the priority order determined by the priority order determination unit 57, the guidance information generation unit 58 generates guidance information for guiding the user with information resulting from a behavior candidate that is output from the behavior candidate presumption unit 56.

As a result, since the plurality of presumed behavior candidates can be narrowed down by following the priority order, behaviors can be predicted with higher accuracy.

The guidance information is generated based on the narrowed-down behavior candidates.

As a result, the guidance information can be generated based on presumption with higher accuracy.

The present invention is not limited to the aforementioned embodiment, and modifications, improvements, etc. within a scope that can achieve the object of the present invention are also included in the present invention.

In the aforementioned embodiment, the four types of movement conditions, i.e. a halt condition, a walking condition, a running condition, or a train-riding condition can be detected by the condition detection processing; however, the present invention is not limited thereto.

For example, a car movement condition, a ship movement condition, a bicycle movement condition, or an airplane movement condition can be detected by the condition detection processing.

In the aforementioned embodiment, the guidance information generation unit 58 generates guidance information for displaying the time table on the display of the output unit 19, in which the time table is information resulting from a behavior candidate; however, the present invention is not limited thereto.

For example, the guidance information generation unit 58 can generate guidance information for displaying store information and sale information of shops in the neighborhood of a station where the user transfers.

In the abovementioned embodiment, a smartphone has been described as an example of the information processing apparatus 1 to which the present invention is applied; however, the present invention is not particularly limited thereto.

For example, the present invention can be applied to electronic devices in general having a display function.

More specifically, for example, the present invention can be applied to a notebook personal computer, a digital camera, a television, a video camera, a portable navigation device, a cell phone device, a portable game device, etc.

The processing sequence described above can be executed by hardware, and can also be executed by software.

In other words, the hardware configuration shown in FIG. 2 is merely an illustrative example, and the present invention is not particularly limited thereto.

More specifically, the types of functional blocks employed to realize the aforementioned functions are not particularly limited to the example in FIG. 2, so long as the information processing apparatus 1 includes the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware.

Alternatively, the computer may be a computer capable of executing various functions by installing various programs, e.g., a general-purpose personal computer.

The storage medium containing such a program can not only be constituted by the removable media 31 shown in FIG. 1 distributed separately from the device main body for supplying the program to a user, but can also be constituted by a storage medium or the like supplied to the user in a state incorporated in the device main body in advance.

The removable medium 31 is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), or the like, for example. The magnetic optical disk is composed of an MD (Mini-Disk) or the like.

The storage medium supplied to the user in a state incorporated in the device main body in advance may include, for example, the ROM 12 shown in FIG. 1, a hard disk included in the storage unit 20 shown in FIG. 1 or the like, in which the program is recorded.

In the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely exemplification, and do not limit the technical scope of the present invention.

Other various embodiments can be employed for the present invention, and various modifications such as omission and replacement are possible without departing from the spirits of the present invention.

Such embodiments and modifications are included in the scope of the invention and the summary described in the present specification, and are included in the invention recited in the claims as well as the equivalent scope thereof.

What is claimed is:

1. An information processing apparatus, comprising:
a positional information acquisition unit that acquires positional information indicating a position of a terminal;
a user condition acquisition unit that acquires user condition information indicating predetermined internal conditions of a user;
a history acquisition unit that associates the positional information acquired by the positional information acquisition unit with the user condition information acquired by the user condition acquisition unit, and acquires these information as user behavior history; and
a behavior candidate presumption unit that presumes user behaviors after predetermined timing, and outputs the presumed behaviors as behavior candidates, based on the positional information acquired by the positional information acquisition unit at the predetermined timing, the user condition information acquired by the user condition acquisition unit at the predetermined timing, and the user behavior history acquired by the history acquisition unit before the predetermined timing.

2. The information processing apparatus according to claim 1, further comprising:
a time acquisition unit that acquires time when the positional information is acquired by the positional information acquisition unit,
wherein the history acquisition unit further associates the time acquired by the time acquisition unit with the positional information and the user condition information, and acquires these information as the user behavior history, and wherein the behavior candidate presumption unit presumes user behaviors after the predetermined timing, and outputs the presumed behaviors as behavior candidates, based on the positional information and the user condition information acquired at the predetermined timing, the user behavior history before the predetermined timing, and the time acquired by the time acquisition unit at the predetermined timing.

3. The information processing apparatus according to claim 2,
wherein the history acquisition unit further includes a behavior pattern generation unit that generates a plurality of user behavior patterns, based on the user behavior history that is stored, and
wherein the behavior candidate presumption unit presumes user behaviors, and outputs the presumed behaviors as behavior candidates, based on the behavior patterns generated by the behavior pattern generation unit.

4. The information processing apparatus according to claim 1,
wherein the history acquisition unit further includes an associated information storage unit that identifies an operation associated with an operation content of the information processing apparatus operated by the user when the user condition information acquired by the user condition acquisition unit is changed, and stores, as associated information, information indicating the operation content that is identified and associated, and
wherein the behavior candidate presumption unit presumes user behaviors by referring to the associated information stored in the associated information storage unit, and outputs the presumed behaviors as behavior candidates.

5. The information processing apparatus according to claim 4,
wherein the history acquisition unit further includes a behavior pattern generation unit that generates a plurality of user behavior patterns, based on the user behavior history that is stored,
wherein the behavior candidate presumption unit presumes user behaviors, and outputs the presumed behaviors as behavior candidates, based on the behavior patterns generated by the behavior pattern generation unit.

6. The information processing apparatus according to claim 1, further comprising:
a guidance information generation unit that generates guidance information for guiding the user with information resulting from the behavior candidates that are output from the behavior candidate presumption unit.

7. The information processing apparatus according to claim 6,
wherein the behavior candidate presumption unit presumes a plurality of user behaviors, and outputs the plurality of behaviors as a plurality of behavior candidates, respectively,
wherein the information processing apparatus further includes a priority order determination unit that determines a priority order of the plurality of behavior candidates that are output from the behavior candidate presumption unit, and
wherein the guidance information generation unit generates guidance information for guiding the user with information resulting from the behavior candidates that are output from the behavior candidate presumption unit, in an order that is determined based on the priority order determined by the priority order determination unit.

8. An information processing method executed by an information processing apparatus, the method comprising:
a positional information acquisition step of acquiring positional information indicating a position of a terminal;
a user condition acquisition step of acquiring user condition information indicating predetermined internal conditions of a user;
a history acquisition step of associating the positional information acquired in the positional information acquisition step with the user condition information acquired in the user condition acquisition step, and acquiring these information as user behavior history; and
a behavior candidate presumption step of presuming user behaviors after predetermined timing, and outputs the presumed behaviors as behavior candidates, based on the positional information acquired in the positional information acquisition step at the predetermined timing, the user condition information acquired in the user condition acquisition step at the predetermined timing, and the user behavior history acquired in the history acquisition step before the predetermined timing.

9. A storage medium storing a program for a computer that controls information processing, the program causing the computer to function as:
a positional information acquisition unit that acquires positional information indicating a position of a terminal;
a user condition acquisition unit that acquires user condition information indicating predetermined internal conditions of a user;
a history acquisition unit that associates the positional information acquired by the positional information acquisition unit with the user condition information acquired by the user condition acquisition unit, and acquires these information as user behavior history; and
a behavior candidate presumption unit that presumes user behaviors after predetermined timing, and outputs the presumed behaviors as behavior candidates, based on the positional information acquired by the positional information acquisition unit at the predetermined timing, the user condition information acquired by the user condition acquisition unit at the predetermined timing, and the user behavior history acquired by the history acquisition unit before the predetermined timing.
